(19) United States
(12) Patent Application Publication
(10) Pub. No.: US 2026/0328135 A1
(43) Pub. Date: Oct. 22, 2026

(54) EXTENDED-EXPANSION ENGINE WITH VARIABLE COMPRESSION RATIO FOR LONGITUDINAL MOUNTING APPLICATIONS

(71) Applicant: GM GLOBAL TECHNOLOGY OPERATION LLC, Detroit, MI (US)

(72) Inventors: Justin Edward KETTERER, LaSalle (CA); Ryan Michael HEINBUCH, Commerce Township, MI (US)

(21) Appl. No.: 19/186,305

(22) Filed: Apr. 22, 2025

(51) Int. Cl. F02B 75/04; F02D 15/02

(52) U.S. Cl. CPC F02B 75/048; F02D 15/02

(57) ABSTRACT

An engine assembly including: a crankshaft extending in a first plane; center links mounted to the crankshaft; piston connecting rods connecting the center links to pistons; a control shaft extending parallel to the crankshaft in a second plane that is above the first plane; control rods connecting the center links to the control shaft; and a phasing device in cooperation with the control shaft and configured to control an engine compression ratio.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to engines with an extended expansion phase and a variable compression ratio.

An extended expansion phase of an engine refers to a deliberately lengthened period during a power stroke when high-pressure combustion gases expand against a piston. The extended expansion phase allows the gases to perform work over a greater distance or time, which can improve the overall thermal efficiency of the engine. Specifically, the extended expansion phase allows for more complete expansion of burned gases, which maximizes extracted work from the burned gas charge. To further optimize performance and fuel efficiency, the compression ratio of the engine may be adjusted dynamically during operation. A variable compression ratio engine adjusts its compression ratio on the fly, such as by using a multi-link system that alters the piston's stroke length, for example. This allows the engine to optimize efficiency depending on driving conditions by changing the volume above the piston at top dead center, essentially switching between high compression and low compression ratios to vary power output and enhance fuel efficiency.

### SUMMARY

The present disclosure provides for, in various features, an engine assembly including: a crankshaft extending in a first plane; center links mounted to the crankshaft; piston connecting rods connecting the center links to pistons; a control shaft extending parallel to the crankshaft in a second plane that is above the first plane; control rods connecting the center links to the control shaft; and a phasing device in cooperation with the control shaft and configured to control an engine compression ratio.

In further features, the phasing device is coplanar with, or above, the crankshaft.

In further features, the control shaft is above the crankshaft and the phasing device.

In further features, the engine assembly is configured to be longitudinally mounted in a vehicle.

In further features, each one of the center links defines a center aperture through which the crankshaft extends, a first side aperture at which one of the piston connecting rods is mounted, and a second side aperture at which one of the control rods is mounted.

In further features, the center aperture is defined by both a first half of the center link and a second half of the center link, the first side aperture is defined by the first half of the center link, and the second side aperture is defined by the second half of the center link; and the first half and the second half of the center link are fastened together by a first fastener between the center aperture and the first side aperture, and a second fastener between the center aperture and the second side aperture.

In further features, the first fastener and the second fastener extend in a direction perpendicular to a center longitudinal axis of the center aperture, and both the first fastener and the second fastener are accessible from below the crankshaft.

In further features, cooperation between the control rods and both the control shaft and the center links results in the controls rods being subject to compressive loads during a power stroke of the engine assembly.

In further features, a center longitudinal axis of the center aperture extends parallel to both a first side longitudinal axis of the first side aperture and a second side longitudinal side axis of the second side aperture.

In further features, each one of the first side longitudinal axis and the second side longitudinal axis are on a common plane.

In further features, an expansion stroke of the pistons is up to 1.4 times longer than a compression stroke of the pistons.

The present disclosure also provides for, in various features, an engine assembly including: a crankshaft extending in a first plane; center links mounted to the crankshaft; piston connecting rods connecting the center links to pistons; a control shaft extending parallel to the crankshaft in a second plane that is above the first plane; control rods connecting the center links to the control shaft; and a phasing device in cooperation with the control shaft and configured to control an engine compression ratio, the phasing device is coplanar with, or above, the crankshaft. The control shaft is above the crankshaft and the phasing device.

In further features, each one of the center links defines a center aperture through which the crankshaft extends, a first side aperture at which one of the piston connecting rods is mounted, and a second side aperture at which one of the control rods is mounted.

In further features, each one of the center links includes a first portion and a second portion defining the center aperture, the first portion and the second portion fastened together by a first fastener between the center aperture and the first side aperture, and a second fastener between the center aperture and the second side aperture.

In further features, the first fastener and the second fastener extend in a direction perpendicular to a center longitudinal axis of the center aperture, and both the first fastener and the second fastener are accessible from below the crankshaft.

In further features, a center longitudinal axis of the center aperture extends parallel to both a first side longitudinal axis of the first side aperture and a second side longitudinal side axis of the second side aperture; and the first side longitudinal axis and the second side longitudinal axis are on a common plane.

The present disclosure still further provides for an engine assembly including: a crankshaft extending in a first plane; center links mounted to the crankshaft; piston connecting rods connecting the center links to pistons; a control shaft extending parallel to the crankshaft in a second plane that is above the first plane; control rods connecting the center links to the control shaft; and a phasing device in cooperation with the control shaft and configured to control an engine compression ratio, the phasing device is coplanar with, or above, the crankshaft. The center links each define a center aperture through which the crankshaft extends, a first side aperture at which one of the piston connecting rods is mounted, and a second side aperture at which one of the control rods is mounted. A center longitudinal axis of the center aperture extends parallel to both a first side longitudinal axis of the first side aperture and a second side longitudinal side axis of the second side aperture. The first side longitudinal axis and the second side longitudinal axis are aligned on a common plane.

In further features, the control shaft is above the crankshaft and the phasing device.

In further features, an expansion stroke of the pistons is up to 1.4 times longer than a compression stroke of the pistons.

In further features, wherein the engine assembly is configured to be longitudinally mounted in a vehicle.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates an exemplary engine assembly in accordance with the present disclosure arranged longitudinally in an exemplary vehicle;

FIG. 2 is a perspective view of the engine assembly of FIG. 1;

FIG. 3 is another perspective view of the engine assembly of FIG. 1;

FIG. 4 is a side view of the engine assembly of FIG. 1;

FIG. 5 illustrates a linkage assembly in accordance with the present disclosure for connecting a crankshaft to a piston, an eccentric shaft, and a phasing device;

FIG. 6 is another view of the linkage assembly of FIG. 5;

FIG. 7A is a plan view of a center link of the linkage assembly;

FIG. 7B is a perspective view of the center link of FIG. 7A; and

FIG. 8 is a piston motion graph for pistons of the engine assembly of FIG. 1.

In the drawings, reference numbers may be reused to identify similar and/or identical elements.

### DETAILED DESCRIPTION

The present disclosure provides for an engine assembly configured to be mounted longitudinally in any suitable vehicle. The engine assembly includes an eccentric control shaft arranged in a plane above a crankshaft. As a result of mounting the eccentric control shaft above the crank shaft, packaging space below the engine assembly is freed-up to accommodate steering components and four-wheel drive components, for example. The engine assembly includes a linkage between the crankshaft, the eccentric control shaft, pistons, and a phasing device. The linkage is specifically configured to accommodate the position of the eccentric control shaft above the crankshaft. The linkage also provides various efficiencies. For example, the linkage provides extended expansion strokes for the pistons as well as faster expansion because fewer crank angle degrees are needed to move the pistons to full expansion. Still further, enhanced compression ratios and expansion ratios are provided as explained herein.

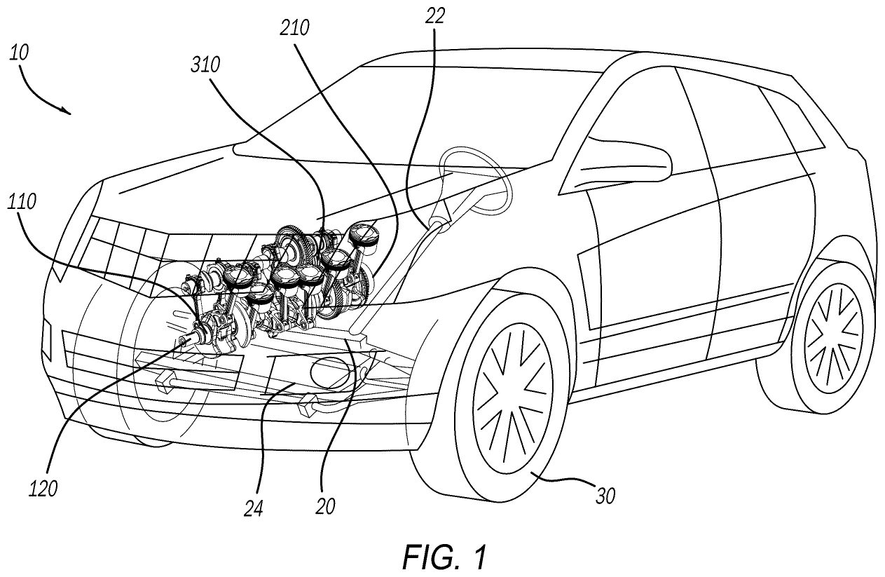

FIG. 1 illustrates a vehicle 10 including an engine assembly 110 in accordance with the present disclosure. The vehicle 10 to may be any suitable vehicle, such as a vehicle configured for the engine assembly 110 to be mounted therein in a longitudinal direction. When mounted in the longitudinal direction, a crankshaft 120 of the engine assembly 110 extends parallel to, or generally parallel to, a longitudinal axis of the vehicle 10. The vehicle 10 may also be configured for the engine assembly 110 to be mounted transversely with the crankshaft 120 extending perpendicular to the longitudinal axis of the vehicle 10.

In the example of FIG. 1, the vehicle 10 includes a steering system 20 with a steering column 22 and a steering linkage 24. A portion of the steering linkage 24 extends between front wheels 30. The engine assembly 110 is configured to be mounted in the vehicle 10 longitudinally over the steering linkage 24 and adjacent to the steering column 22. The engine assembly 110 is also configured to be mounted transversely over the steering linkage 24. The engine assembly 110 is configured for use with any suitable non-automotive application as well.

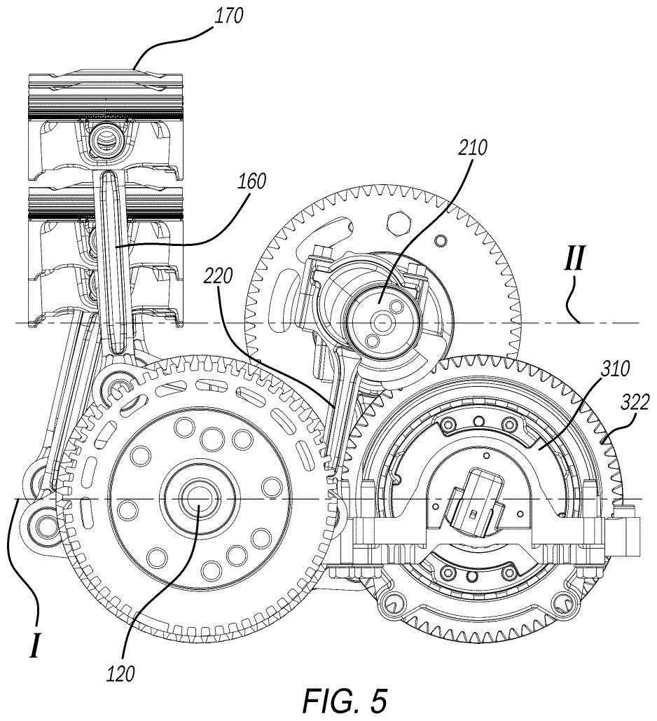

To facilitate mounting of the engine assembly 110 over the steering linkage 24, the engine assembly 110 is configured such that a control shaft 210 (eccentric control shaft) is above the crankshaft 120. The engine assembly 110 further includes a phasing device 310, which is coplanar with, or above, the crankshaft 120 (see FIG. 5, for example). As described herein, the engine assembly 110 includes a linkage particularly configured for mounting the control shaft 210 above the crankshaft 120, and mounting the phasing device 310 above the crankshaft 120 or coplanar with the crankshaft 120. Longitudinal mounting of the engine assembly 110 (such as in a rear-wheel drive or four-wheel drive vehicle) frees up space for the steering system 20 and various four-wheel drive hardware. In particular, mounting the control shaft 210 at a high eccentric position above the crankshaft 120 frees up space for the steering system 20, engine mounts, etc. in a longitudinal orientation. Engine assemblies with the control shaft below the crankshaft experience interference issues when the engine is mounted longitudinally.

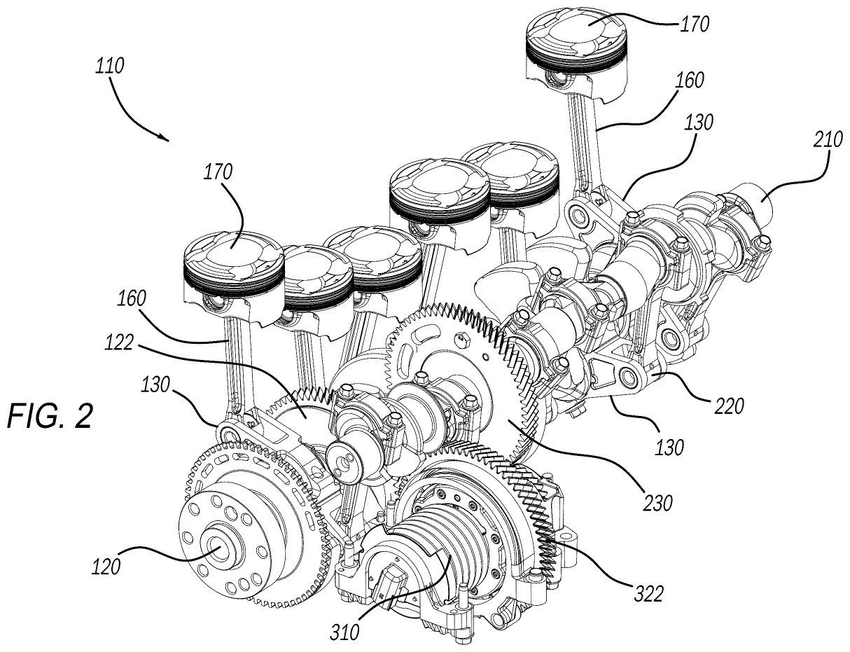

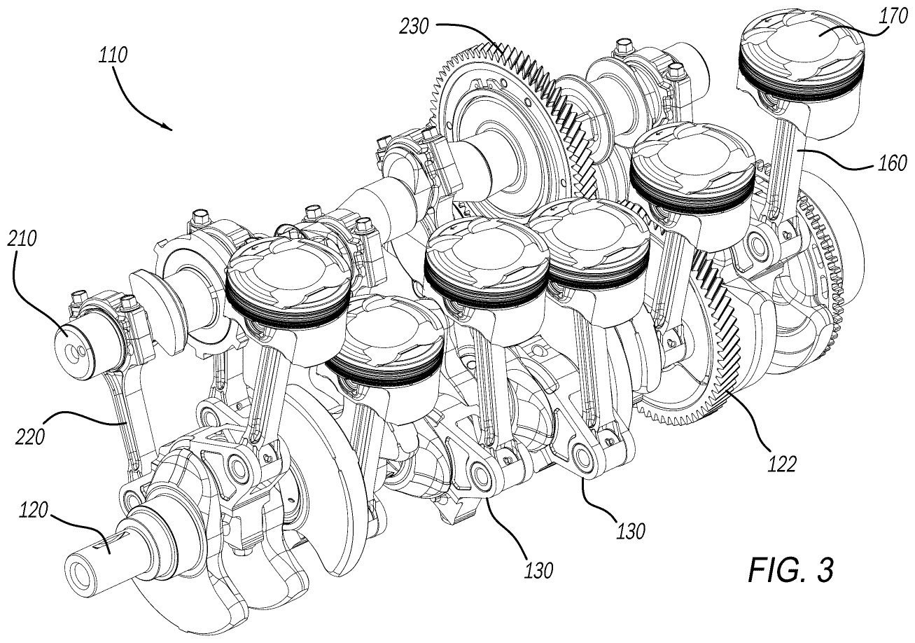

With continued reference to FIG. 1, and additional reference to FIGS. 2-6, the engine assembly 110 includes a plurality of center links 130 on the crankshaft 120. One end of each center link 130 is mounted to a piston connecting rod 160, which is mounted to a piston 170, to connect each center link 130 to one of the pistons 170. An opposite end of each center link 130 is mounted to the control shaft 210 by way of a control rod 220.

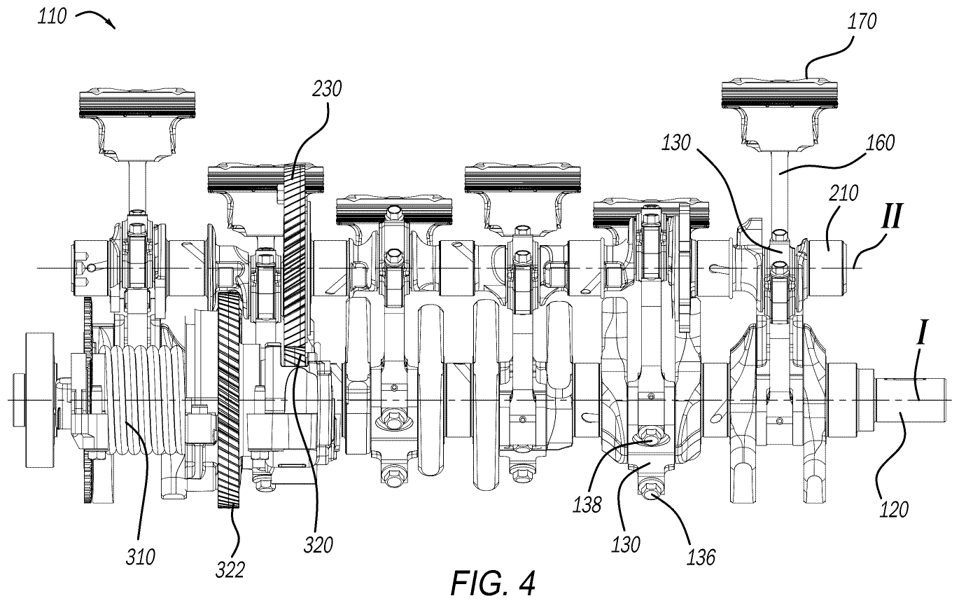

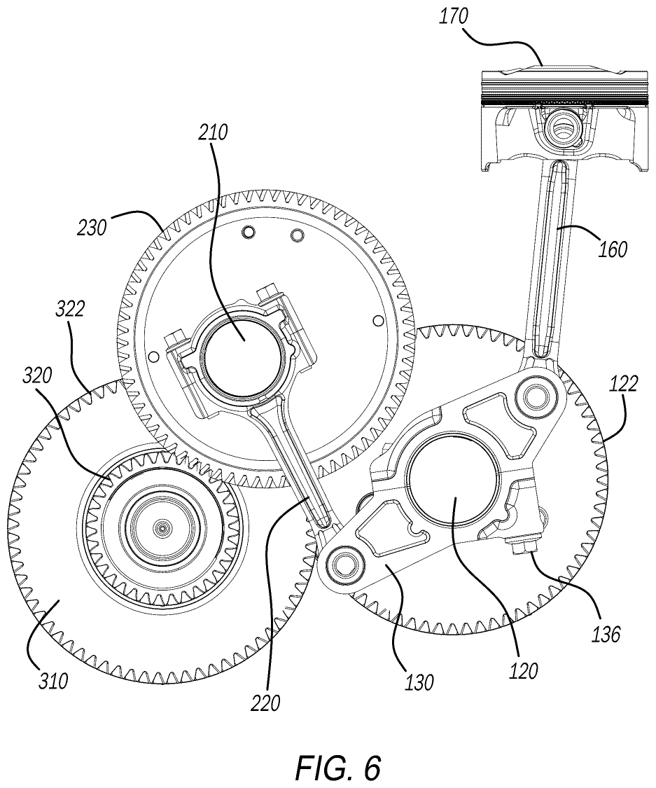

The phasing device 310 is in cooperation with both the crankshaft 120 and the control shaft 210. In particular, the phasing device 310 includes a first gear 320 in cooperation with a control gear 230 on the control shaft 210 (see FIGS. 4 and 6, for example). The phasing device 310 also includes a second gear 322 in cooperation with a crankshaft gear 122 (see FIG. 2, for example). The phasing device 310 is configured to vary a compression ratio of the engine assembly 110 by modifying a phase angle between the crankshaft 120 and the control shaft 210. Modifying the phase angle changes the length of the piston stroke. The compression ratio change is due to a change in the top dead center position.

The crankshaft 120 and the control shaft 210 extend in parallel to each other. The engine assembly 110 is configured such that the crankshaft 120 extends in a first plane I, and the control shaft 210 extends in a second plane II. The second plane II is above the first plane I. The phasing device 310 is arranged on or above the first plant I. Thus, the phasing device 310 is coplanar with the crankshaft 120 or above the crankshaft 120. This orientation accommodates components of the steering system 20 of the vehicle 10. Specifically, arranging the control shaft 210 in the second plane II above the first plane I of the crankshaft 120 (as opposed to arranging the control shaft 210 below the first plane I) makes space for the steering linkage 24 and other components of the steering system 20. This orientation also facilitates arrangement of the engine assembly 110 longitudinally in the vehicle 10.

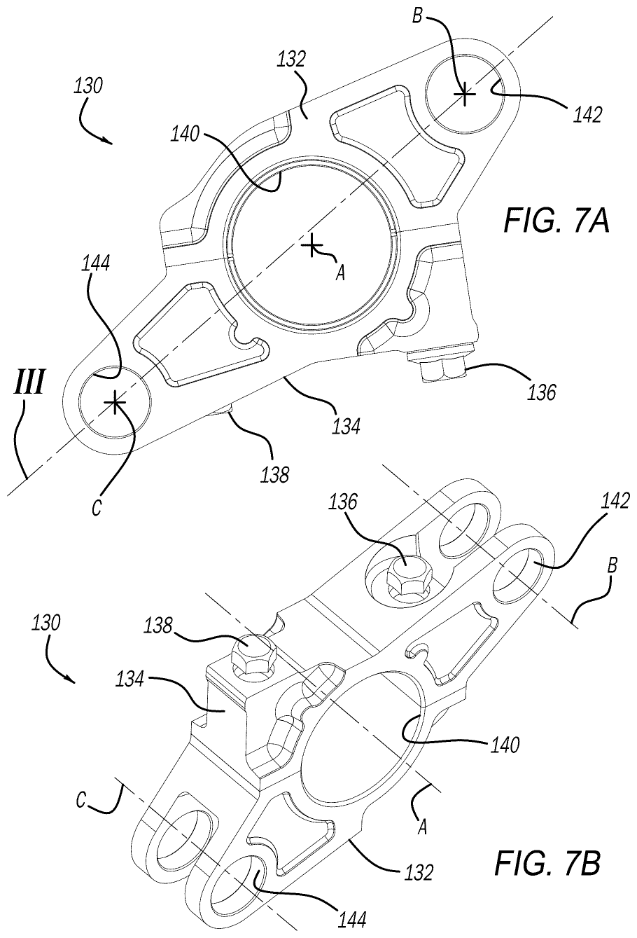

With particular reference to FIGS. 6, 7A, and 7B, a linkage between the crankshaft 120, the piston 170, the control shaft 210, and the phasing device 310 will now be described. This linkage makes it possible to mount the control shaft 210 in the second plane II above the first plane I including the crankshaft 120. The linkage includes a plurality of the center links 130. Each one of the center links 130 includes a first portion 132 fastened to a second portion 134. With particular reference to FIG. 7A and FIG. 7B, the first portion 132 is fastened to the second portion 134 with a first fastener 136 and a second fastener 138. To fasten the center link 130 to the crankshaft 120, the first portion 132 and the second portion 134 may be individually seated on the crankshaft 120, and then coupled together with the first fastener 136 and the second fastener 138.

The first portion 132 and the second portion 134 of the center link 130 together define a center aperture 140. The first portion 132 defines a first side aperture 142, which may be a single aperture or include two spaced apart apertures as illustrated. The second portion 134 defines a second side aperture 144, which may be a single aperture or include two spaced apart apertures as illustrated. The center link 130 is configured to accommodate the first fastener 136 between the center aperture 140 and the first side aperture 142, and configured to accommodate the second fastener 138 between the center aperture 140 and the second side aperture 144.

A center longitudinal axis A extends through a center of the center aperture 140. A first side axis B extends through a center of the first side aperture 142. And a second side axis C extends through a center of the second side aperture 144. Each one of the center axis A, the first side axis B, and the second side axis C extend parallel to each other. With particular reference to FIG. 7A, each one of the center axis A, the first side axis B, and the second side axis C may be aligned on a common plane, or slightly offset therefrom. The first side aperture 142 and the second side aperture 144 may be slightly offset from (in a slightly different plane from) the center aperture 140 therebetween. The first side aperture 142 and the second side aperture 144 may be aligned along a third plane III.

With particular reference to FIG. 6, the center link 130 is mounted on the crankshaft 120 with the crankshaft 120 extending through the center aperture 140. The piston connecting rod 160 is mounted at the first side aperture 142 to connect the center link 130 to the piston 170. And the control rod 220 of a control linkage is mounted at the second side aperture 144 to connect the center link 130 to the control shaft 210. FIG. 6 also illustrates the phasing device 310 connected to the control shaft 210 by way of cooperation between the first gear 320 of the phasing device 310 and the control gear 230 on the control shaft 210.

The linkage assembly between the crankshaft 120, the piston 170, the control shaft 210, and the phasing device 310 provides various advantages. For example, the center link 130 is configured to accommodate the first fastener 136 between the center aperture 140 and the first side aperture 142, and accommodate the second fastener 138 between the center aperture 140 and the second side aperture 144, while still allowing the center link 130 to cooperate with the piston connecting rod 160 and the control rod 220 extending upward to the control shaft 210. Arranging the first fastener 136 and the second fastener 138 on opposite sides of the center aperture 140 also strengthens the connection between the center link 130 and the crankshaft 120. Both the first fastener 136 and the second fastener 138 are accessible at the second portion 134 of the center link 130, which is generally a bottom of the center link 130, to provide tool access to the first fastener 136 and the second fastener 138 during servicing and/or assembly.

The linkage assembly also accommodates application of compressive loads on the control rod 220 (which is in contrast to the tensile loading that the control rod 220 would be subject to when the control shaft 210 is below the crankshaft 120), and permits the use of lubrication schemes from conventional connecting rods to be applied (which is in contrast to low-mounted control shafts requiring less-effective lubrication arrangements). The linkage assembly further accommodates at least the following: limits on the length of the control rod 220 due to the presence of the phasing device 310; constraints on the position of the control shaft 210 due to presence of engine mounts and an oil gallery; and limits on motion of the piston 170 due to length of an associated liner.

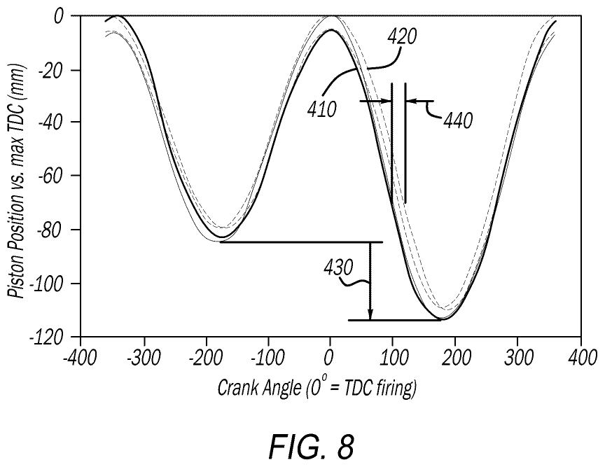

FIG. 8 illustrates piston motion 410 for the piston 170 of the present disclosure versus piston motion 420 for a piston of an engine assembly having the control shaft below the crankshaft. The y-axis indicates position of the piston 170 relative to a maximum top dead center (TDC) in millimeters. The x-axis indicates the crank angle of the crankshaft 120 with 0° being top dead center firing. As shown at 430, the piston motion 410 of the engine assembly 110 provides for an extended expansion factor of up to 1.4 times longer than the intake compression stroke, which increases engine efficiency. In some applications, this expansion factor is greater than that provided by the piston of the engine assembly with the low control shaft. There is flexibility in the range of expansion factors that can be achieved with the linkage configuration, however.

As shown at 440 of FIG. 8, the linkage of the engine assembly 110 also provides a faster expansion stroke by reducing the number of crank angle degrees needed for the piston 170 to reach full expansion (thereby reducing engine knock, for example) as compared to the number of degrees required by the piston of an engine assembly with the low control shaft. The engine assembly 110 of the present disclosure also provides a phasing range of the control shaft 210 of about 32° (such as from −15° to +17°), which provides an enhanced variable compression ratio of between about 7:1 and 11:1, and an enhanced expansion ratio of about 10:1 to 15:1.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

1. An engine assembly comprising:
a crankshaft extending in a first plane;
center links mounted to the crankshaft;
piston connecting rods connecting the center links to pistons;
a control shaft extending parallel to the crankshaft in a second plane that is above the first plane;
control rods connecting the center links to the control shaft; and
a phasing device in cooperation with the control shaft and configured to control an engine compression ratio,
wherein:
each one of the center links defines a center aperture through which the crankshaft extends, a first side aperture at which one of the piston connecting rods is mounted, and a second side aperture at which one of the control rods is mounted,
the center aperture is defined by both a first half of the center link and a second half of the center link, the first side aperture is defined by the first half of the center link, and the second side aperture is defined by the second half of the center link, and
the first half and the second half of the center link are fastened together by a first fastener between the center aperture and the first side aperture, and a second fastener between the center aperture and the second side aperture.

2. The engine assembly of claim 1, wherein the phasing device is coplanar with, or above, the crankshaft.

3. The engine assembly of claim 1, wherein the control shaft is above the crankshaft and the phasing device.

4. The engine assembly of claim 1, wherein the engine assembly is configured to be longitudinally mounted in a vehicle.

5.-6. (canceled)

7. The engine assembly of claim 1, wherein the first fastener and the second fastener extend in a direction perpendicular to a center longitudinal axis of the center aperture, and both the first fastener and the second fastener are accessible from below the crankshaft.

8. The engine assembly of claim 1, wherein cooperation between the control rods and both the control shaft and the center links results in the controls rods being subject to compressive loads during a power stroke of the engine assembly.

9. The engine assembly of claim 8, wherein a center longitudinal axis of the center aperture extends parallel to both a first side longitudinal axis of the first side aperture and a second side longitudinal side axis of the second side aperture.

10. The engine assembly of claim 9, wherein each one of the first side longitudinal axis and the second side longitudinal axis are on a common plane.

11. The engine assembly of claim 1, wherein an expansion stroke of the pistons is up to 1.4 times longer than a compression stroke of the pistons.

12. An engine assembly comprising:
a crankshaft extending in a first plane;
center links mounted to the crankshaft;
piston connecting rods connecting the center links to pistons;
a control shaft extending parallel to the crankshaft in a second plane that is above the first plane;
control rods connecting the center links to the control shaft; and
a phasing device in cooperation with the control shaft and configured to control an engine compression ratio, the phasing device is coplanar with, or above, the crankshaft,
wherein:
the control shaft is above the crankshaft and the phasing device,
each one of the center links defines a center aperture through which the crankshaft extends, a first side aperture at which one of the piston connecting rods is mounted, and a second side aperture at which one of the control rods is mounted,
the center aperture is defined by both a first half of the center link and a second half of the center link, the first side aperture is defined by the first half of the center link, and the second side aperture is defined by the second half of the center link, and
the first half and the second half of the center link are fastened together by a first fastener between the center aperture and the first side aperture, and a second fastener between the center aperture and the second side aperture.

13.-14. (canceled)

15. The engine assembly of claim 12, wherein the first fastener and the second fastener extend in a direction perpendicular to a center longitudinal axis of the center aperture, and both the first fastener and the second fastener are accessible from below the crankshaft.

16. The engine assembly of claim 12, wherein:
a center longitudinal axis of the center aperture extends parallel to both a first side longitudinal axis of the first side aperture and a second side longitudinal side axis of the second side aperture; and
the first side longitudinal axis and the second side longitudinal axis are on a common plane.

17. An engine assembly comprising:
a crankshaft extending in a first plane;
center links mounted to the crankshaft;
piston connecting rods connecting the center links to pistons;
a control shaft extending parallel to the crankshaft in a second plane that is above the first plane;
control rods connecting the center links to the control shaft; and
a phasing device in cooperation with the control shaft and configured to control an engine compression ratio, the phasing device is coplanar with, or above, the crankshaft,
wherein:
the center links each define a center aperture through which the crankshaft extends, a first side aperture at which one of the piston connecting rods is mounted, and a second side aperture at which one of the control rods is mounted,
a center longitudinal axis of the center aperture extends parallel to both a first side longitudinal axis of the first side aperture and a second side longitudinal side axis of the second side aperture, and
the first side longitudinal axis and the second side longitudinal axis are aligned on a common plane,
the center aperture is defined by both a first half of the center link and a second half of the center link, the first side aperture is defined by the first half of the center link, and the second side aperture is defined by the second half of the center link, and
the first half and the second half of the center link are fastened together by a first fastener between the center aperture and the first side aperture, and a second fastener between the center aperture and the second side aperture.

18. The engine assembly of claim 17, wherein the control shaft is above the crankshaft and the phasing device.

19. The engine assembly of claim 17, wherein an expansion stroke of the pistons is up to 1.4 times longer than a compression stroke of the pistons.

20. The engine assembly of claim 17, wherein the engine assembly is configured to be longitudinally mounted in a vehicle.
